(19) United States
(12) Patent Application Publication
(10) Pub. No.: US 2025/0106543 A1
(43) Pub. Date: Mar. 27, 2025

(54) OPEN EARPHONE

(71) Applicant: Anker Innovations Technology Co., Ltd., Changsha (CN)

(72) Inventor: Yu Xiao, Shenzhen (CN)

(21) Appl. No.: 18/828,033

(22) Filed: Sep. 9, 2024

(30) Foreign Application Priority Data
Sep. 26, 2023 (CN) 202311248822.7
Sep. 26, 2023 (CN) 202322631620.2

(51) Int. Cl. H04R 1/10; H04R 1/28; H04R 1/34

(52) U.S. Cl. CPC H04R 1/1008; H04R 1/105; H04R 1/1075; H04R 1/2834; H04R 1/345

(57) ABSTRACT

The present application discloses an open earphone. The open earphone comprises a hook-shaped body; and a sound emitting assembly connected to the hook-shaped body. The sound emitting assembly comprises: a sound emitting shell comprising one or more sound emitting apertures and one or more pressure relief apertures; and a sound emitting device in the sound emitting shell. The sound emitting device is located between the one or more sound emitting apertures and the one or more pressure relief apertures. The sound emitting device is configured to transmit sound via at least the one or more sound emitting apertures. The one or more pressure relief apertures are closer to an ear canal opening of an ear than the one or more sound emitting apertures when the open earphone is worn on the ear.

### CROSS-REFERENCE TO RELATED APPLICATIONS

This application claims priority to Chinese Application No. 202311248822.7, filed on Sep. 26, 2023, and Chinese Application No. 202322631620.2, filed on Sep. 26, 2023. The entire disclosures of each of the above applications are incorporated herein by reference.

### FIELD

The present application relates to the technical field of earphones, particularly to an open earphone.

### BACKGROUND

At present, an open earphone product adheres to the outer side of an ear canal and does not cover the ear canal, ensuring a consumer to hear a sound of the earphone as well as external sounds, thus improving safety and comfort. However, an ear canal opening is not sealed with a speaker of the open earphone, resulting in sound leakage.

### SUMMARY

The present application provides an open earphone that can achieve a better effect of suppressing sound leakage. For example, the present application provides an open earphone comprising a securing structure and a sound emitting structure connected with the securing structure, the securing structure being configured to position the sound emitting structure on a front side of an ear of a user in a wearing condition.

The sound emitting structure comprises: a sound emitting shell provided with a sound emitting portion and a pressure relief portion; and a sound emitting unit provided within the sound emitting shell and separating an inner space of the sound emitting shell into a front cavity and a rear cavity, the sound emitting portion communicating with the front cavity, and the pressure relief portion communicating with the rear cavity. The pressure relief portion may be closer to an ear canal opening of an ear than the sound emitting portion in the wearing condition (e.g., when the open earphone is worn on the ear).

The sound emitted from the sound emitting portion and the sound emitted from the pressure relief portion have inverse phases, which can be cancelled. In the present application, the pressure relief portion is closer to the ear canal opening than the sound emitting portion in order to achieve a certain degree of inverse phase cancellation of sound between the sound emitting portion and the ear canal opening, thereby effectively reducing sound leakage on the front side of the ear and improving the user experience.

### BRIEF DESCRIPTION OF THE DRAWINGS

In order to explain technical solutions in the examples of the present application or the related art more clearly, the following will briefly introduce the accompanying drawings required for describing the examples or the related art. Obviously, the accompanying drawings described in the following are only some examples of the present application. For one of ordinary skill in the art, other drawings can be obtained based on the structures shown in these drawings without inventive labor.

FIG. 1 is a schematic view of a structure of an open earphone according to an example of the present application;

FIG. 2 is a schematic view showing a wearing condition in which the open earphone in FIG. 1 fits an ear;

FIG. 3 is a schematic view showing a cross-sectional structure of a sound emitting structure in FIG. 1;

FIG. 4 is a schematic view showing a cross-sectional structure of a sound emitting unit in FIG. 3;

FIG. 5 is a schematic view of a structure of the ear in FIG. 2;

FIG. 6 is a schematic view from another angle of view in which the open earphone in FIG. 1 fits the ear;

FIG. 7 is schematic view of a human body reference;

FIG. 8 is a schematic view showing a cross-sectional structure of a sound emitting structure according to another example;

FIG. 9 is a schematic view from another angle of view of a structure of the open earphone in FIG. 1;

FIG. 10 is a schematic view from another angle of view of a partial structure of a sound emitting structure in FIG. 1;

FIG. 11 is a schematic view from still another angle of view showing a cross-sectional structure of a sound emitting structure in FIG. 1;

FIG. 12 is a schematic view showing a cross-sectional structure of a distribution structure according to an example of the present application;

FIG. 13 is a schematic view showing a cross-sectional structure of a distribution structure according to another example of the present application;

FIG. 14 is a schematic view showing a cross-sectional structure of a distribution structure according to still another example of the present application; and

FIG. 15 is a schematic view showing a cross-sectional structure of a distribution structure according to yet another example of the present application.

Description of Reference Numerals:

| Reference | | Reference | |
|---|---|---|---|
| numeral | Name | numeral | Name |
| 100 | Open earphone | 3153 | Counterweight block |
| 10 | Securing structure | 317 | Distribution structure |
| 11 | Rear end portion | 3171 | Distribution body |
| 13 | Hanging portion | 3173 | Distribution ring |
| 30 | Sound emitting | 3175 | First distribution rib |
| | structure | | |
| 31 | Sound emitting shell | 3177 | Second distribution |
| | | | rib |
| 31a | Front cavity | 3179 | Third distribution rib |
| 31b | Rear cavity | 33 | Sound emitting unit |
| 31c | Sound emitting portion | 331 | Vibrating membrane |
| 31c1 | Sound emitting | 333 | Voice coil assembly |
| | aperture | | |
| 31c11 | Sound emitting | 335 | Magnetic circuit |
| | opening | | system |
| 31c13 | Inner sound emitting | 335a | Magnetic gap |
| | opening | | |
| 31d | Pressure relief portion | 3351 | First magnet |
| 31d1 | Pressure relief aperture | 3353 | Second magnet |
| 31e | Pressure relief channel | 337 | Basket |
| 31f | Installation opening | 337a | Accommodation |
| | | | cavity |
| 311 | Front shell | 339 | Hanging piece |
| 311a | Sound guiding | 35 | Main control panel |
| | structure | | |
| 311b | First surface | 200 | Ear |
| 311c | Second surface | 200a | Ear canal opening |
| 313 | Rear shell | 200b | Cavum conchae |
| 3131 | Rear shell body | 201 | Antihelix |
| 3133 | Rear cavity cover | 202 | Tragus |
| 315 | Passive radiation | 203 | Antitragus |
| | membrane | | |
| 3151 | Membrane body | 204 | Intertragic notch |

Implementation of the purpose, functional characteristics, and advantages of this application will be further explained in conjunction with the examples with reference to the accompanying drawings.

### DETAILED DESCRIPTION

In order to make the purpose, technical solution, and advantages of this application clearer, further detailed descriptions of the examples of this application will be provided below in conjunction with the accompanying drawings.

When the following description involves drawings, unless otherwise indicated, the same numbers in different drawings represent the same or similar elements. The examples described in the following exemplary examples do not represent all examples consistent with the present application. On the contrary, they are only examples of devices and methods consistent with some aspects of the present application as detailed in the attached claims.

In the description of this application, it should be understood that the terms “first”, “second”, etc. are only used for descriptive purposes and cannot be understood as indicating or implying relative importance. For one of ordinary skill in the art, the specific meanings of the above terms in this application can be understood based on specific circumstances. Furthermore and in the description of this application, unless otherwise specified, “a plurality of” refers to two or more. “And/or” describes the association relationship of the associated objects and indicates that there can be three types of relationships, for example, A and/or B can represent three situations, that is, the existence of A alone, both A and B, and the existence of B alone. The character “/” generally indicates that the associated objects are described in an “or” relationship.

Unless otherwise defined, all technical and scientific terms used in this document have the same meanings as those commonly understood by one skilled in the art of this application. The terms used in this specification are only for the purpose of describing specific examples and are not intended to limit the present application. The term “and/or” used in this document includes any and all combinations of one or more related listed items.

At present, an open earphone product adheres to the outer side of an ear canal and does not cover the ear canal, ensuring a consumer to hear a sound of the earphone as well as external sounds, thus improving safety and comfort. However, an ear canal opening is not sealed with a speaker of the open earphone, resulting in sound leakage.

To address the above problem, the application proposes an open earphone 100 (e.g., open-ear earphone, open-ear earbud, open-ear headphone) which may be an air conduction earphone. The air conduction earphone builds in a sound emitting unit and has an aperture opened in a sound cavity for directional sound transmission.

It can be understood that the open earphone 100 should be provided with at least a wearing condition in which the open earphone 100 fits an ear of a user to be fixed relative to the ear. In such a condition, the user can obtain an ideal listening effect.

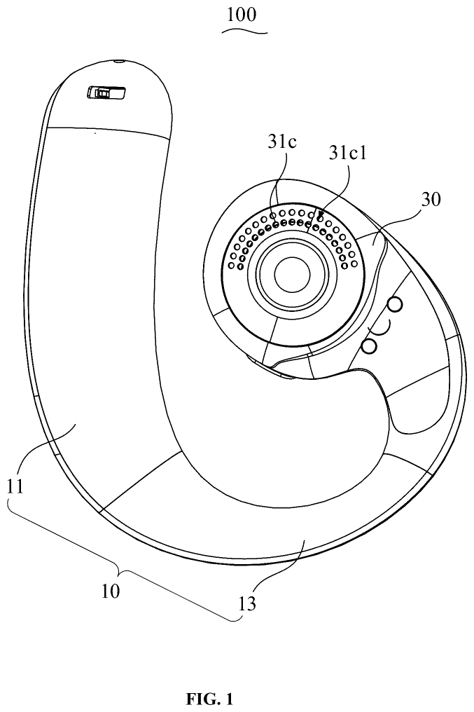

Referring to FIG. 1, an example of the present application provides an air conduction open earphone 100. Compared to a bone conduction earphone, the air conduction open earphone 100 can provide a higher sound quality and less sound leakage due to directional sound propagation.

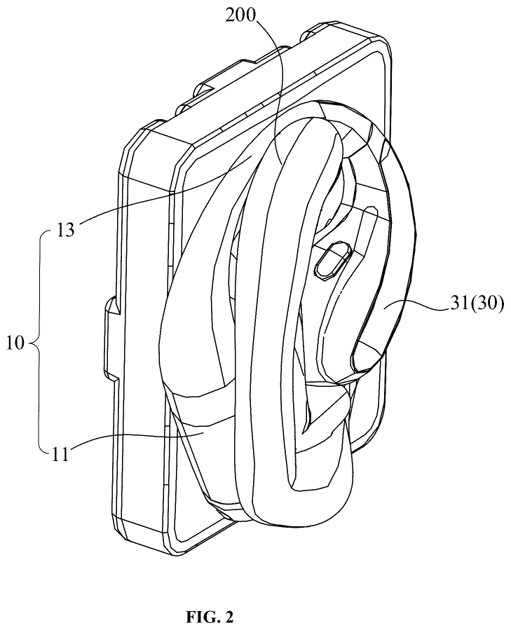

Referring to FIGS. 1 and 2, the open earphone 100 comprises a securing structure 10 and a sound emitting structure 30 connected to the securing structure 10. The securing structure 10 comprises a hanging portion 13 and a rear end portion 11. Among them, the hanging portion 13 is connected to the sound emitting structure 30 and is configured to be hanged between an upper side of an ear 200 and a head of the user in the wearing condition; the rear end portion 11 is provided at an end of the hanging portion 13 away from the sound emitting structure 30 and is configured to be provided between the rear side of the ear 200 and the head of the user in the wearing condition. The hanging portion 13 may be curved in an arc shape and may form a hook shape, and the hanging portion 13 and the rear end portion 11 are at least in contact with front and rear sides of the ear 200 to achieve securing to the ear 200, so that the sound emitting structure 30 connected to one end of the hanging portion 13 can be stably provided on the front side of the ear 200. It can be understood that the hanging portion 13 and/or the rear end portion 11 have certain elasticity, so that the user can bend the hanging portion 13 and/or the rear end portion 11 to fit the securing structure 10 with the ear 200. When the open earphone 100 is worn to the ear 200, the sound emitting structure 30 covers an ear canal opening 200a of the ear 200 and might not extend into the ear canal opening 200a of the ear 200.

Additionally or alternatively, the securing structure 10 comprises a securing shell, and the sound emitting structure 30 comprises a sound emitting shell 31. The securing shell and the sound emitting shell 31 may be two parts that can be detachably connected to each other, or may be machine-formed together.

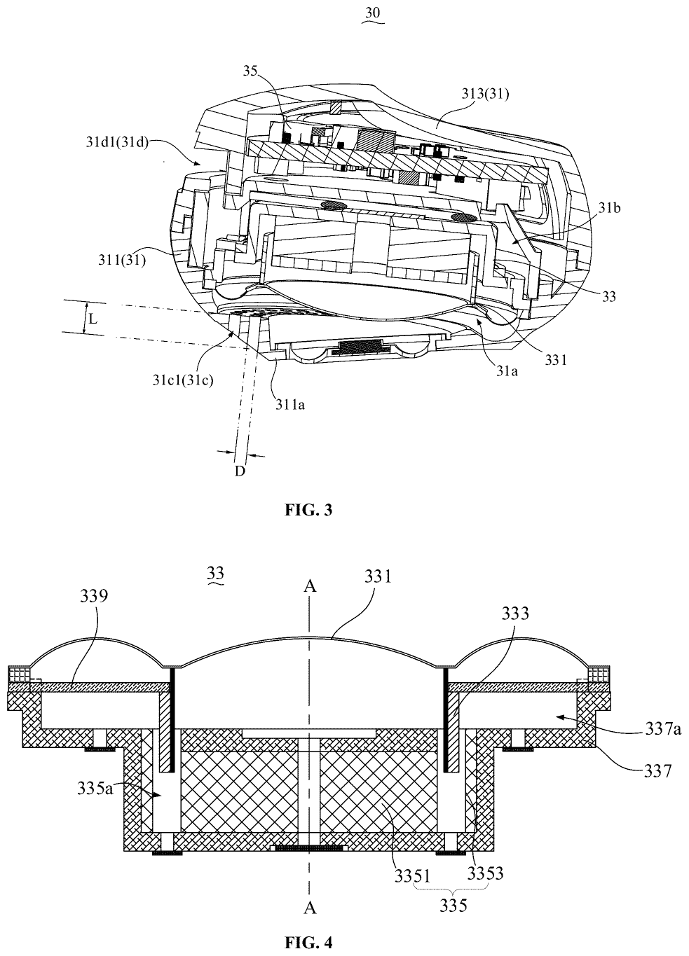

Referring to FIG. 3, the sound emitting structure 30 is configured to emit sound and enable the sound to be transmitted by air to the ear canal opening 200a of the ear 200. The sound emitting structure 30 further comprises a sound emitting unit 33 provided within the sound emitting shell. For the convenience of production, manufacture, and assembly, the sound emitting shell 31 may comprise a front shell 311 and a rear shell 313. When the front shell 311 is docked with the rear shell 313, the two shells enclose to form an installation space. The sound emitting unit 33 is provided in the installation space, and forms a front cavity 31a together with the front shell 311, and forms a rear cavity 31b together with the rear shell 313 or with the rear shell 313 and part of the front shell 311. The front shell 311 is provided with a sound emitting portion 31c which communicates with the front cavity 31a. The rear shell 313 is provided with a pressure relief portion 31d which communicates with (e.g., is connected to) the rear cavity 31b. The sound emitting portion 31c may be provided as an opening or an aperture (e.g., sound emitting aperture 31c1), and the pressure relief portion 31d may also be provided as an opening or an aperture (e.g., pressure relief aperture 31d1) without specific limitations. The sound emitting unit 33 is provided with a vibrating membrane 331. By vibrating the vibrating membrane 331 to vibrate air, air can transmit sound through the sound emitting portion 31c.

It can be understood that the open earphone 100 further comprises a main control panel 35 and a battery. The main control panel 35 is connected to the rear shell 313 and electrically connected to the sound emitting unit 33 to control vibration of the vibrating membrane 331 of the sound emitting unit 33 for sound emitting. The battery is electrically connected to the main control panel 35 to provide power for the sound emitting unit 33. The battery generally has a large mass. In an example, the battery is provided at the rear end portion 11 and can fit the sound emitting structure 30 to make weight distribution of the open earphone 100 more uniform. Therefore, in the wearing condition, the sound emitting structure 30 and the battery are provided on the front and rear sides of the ear 200, making wearing more comfortable and reliable.

Referring to FIG. 4, the sound emitting unit 33 comprises a basket 337, a magnetic circuit system 335 (e.g., one or more magnets), a vibration system, and a hanging piece 339. The basket 337 is provided with an accommodation cavity 337a and an opening communicating with (e.g., connected to) the accommodating cavity 337a. The magnetic circuit system 335 is provided within the accommodating cavity 337a and connected to the basket 337. The vibration system comprises a vibrating membrane 331 and a voice coil assembly 333. The vibrating membrane 331 covers the opening and is connected to the basket 337. The voice coil assembly 333 is located within the accommodating cavity 337a and is connected to the vibrating membrane 331. In a specific example, the magnetic circuit system 335 comprises a first magnet 3351 and a second magnet 3353 provided surrounding the first magnet 3351, and there is a magnetic gap 335a between the first magnet 3351 and the second magnet 3353. The voice coil assembly 32 is inserted in the magnetic gap 335a. The hanging piece 339 is located in the accommodating cavity 337a, provided in a direction intersecting with an axial direction A-A of the voice coil assembly 333, and connected to the basket 337 and the voice coil assembly 333.

Specifically, taking the opening located above the accommodation cavity 337a as an example, the voice coil assembly 333 is located within the accommodation cavity 337a, the vibrating membrane 331 covers the opening of the accommodation cavity 337a, and the voice coil assembly 333 is connected to the vibrating membrane 331. The vibrating membrane 331 exerts a vertical acting force on the voice coil assembly 333; the hanging piece 339 exerts an acting force on voice coil assembly 333 in an inclined direction. At this time, the voice coil assembly 333 exerts two acting forces facing different directions. The present example does not limit an intersection angle between the direction of the hanging piece 339 and the axial direction A-A of the voice coil assembly 333. The hanging piece 339 may be arranged perpendicularly to the axis direction of the voice coil assembly 333 (e.g., the hanging piece 339 is arranged in a direction perpendicular to the axis direction A-A of the voice coil assembly 333). By the hanging piece 339 being configured in such way that the hanging piece 339 and the vibrating membrane 331 can simultaneously exert acting force on the voice coil assembly 333, the number of points of acting force of the voice coil assembly 333 is increased, thereby reducing the polarization of the voice coil and reducing the friction between the voice coil assembly 333, the magnetic circuit system 335, and the basket 337. Due to the less polarization of the voice coil assembly 333, the size of the gap between voice coil assembly 333 and the magnetic circuit system 335 can also be set to be smaller, such that the voice coil assembly 333 is closer to the dense area of the magnetic field line of magnetic circuit system 335, and the Lorentz force received by the voice coil assembly 333 when powered on is greater. As a result, the efficiency of driving the sound emitting unit 33 is higher, the amplitude of vibration of the sound emitting unit 331 is larger, resulting in a greater output sound.

For example, the vibrating membrane 331 has an amplitude greater than or equal to 0.5 mm and less than 2.0 mm. The vibrating membrane 331 pushes the air with an amplitude of more than 0.5 mm, achieving a higher low-frequency sound pressure level and a subjective listening sensation with deep diving and impressive bass, which to some extent compensates for the serious problem of bass loss caused by the outward diffusion of low-frequency sound in a high leakage state of the sound in the open earphone 100.

The vibration of the vibrating membrane 331 can cause the air in the front cavity 31a and the rear cavity 31b to produce vibrations with opposite (e.g., inverse) phases. Therefore, the sound emitted from the sound emitting portion 31c and the pressure relief portion 31d may have opposite phases, which can achieve a certain degree of mutual cancellation, thereby depressing the phenomenon of sound leakage. This kind of cancellation presents a strong effect of proximal end cancellation and a weak effect of distal end cancellation, thus meeting the design of reducing sound leakage.

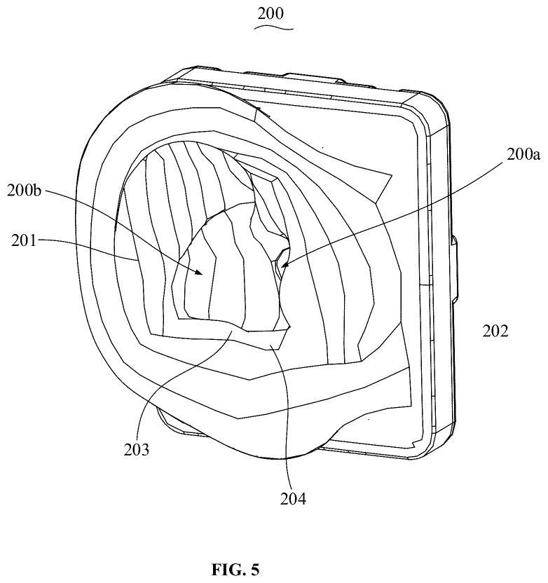

Among them and referring to FIGS. 3, 5, and 6, in the example of the present application, the sound emitting portion 31c faces towards the ear 200, and to ensure the listening effect, the sound emitting portion 31c is located inside the cavum conchae 200b of the ear 200 in the wearing condition, but might not extend into the ear canal opening 200a of the ear 200, and is positioned at intervals with the ear canal opening 200a of the ear 200, thus fully utilizing the space in the ear 200 near the ear canal opening 200a, forming a space for scattering and reverberation, and achieving a better listening effect. In an example of the present application, when the open earphone 100 is worn by a user, the pressure relief portion 31d is closer to the ear canal opening 200a of the ear 200 than the sound emitting portion 31c. In the wearing condition, the sound emitting shell 31 is at a considerable distance from the ear canal opening 200a of the ear 200 to achieve less obstruction of external sound entering the ear canal opening 200a. It is also likely to occur sound leakage between the sound emitting structure 30 and the ear canal opening 200a of the ear 200. In the example of the present application, the pressure relief portion 31d is closer to the ear canal opening 200a of the ear 200 than the sound emitting portion 31c, in order to achieve a certain degree of reverse cancellation of sound between the sound emitting portion 31c and the ear canal opening 200a of the ear 200, thereby effectively reducing sound leakage near the ear canal opening 200a of the ear 200 at the front side thereof and improving the user's experience.

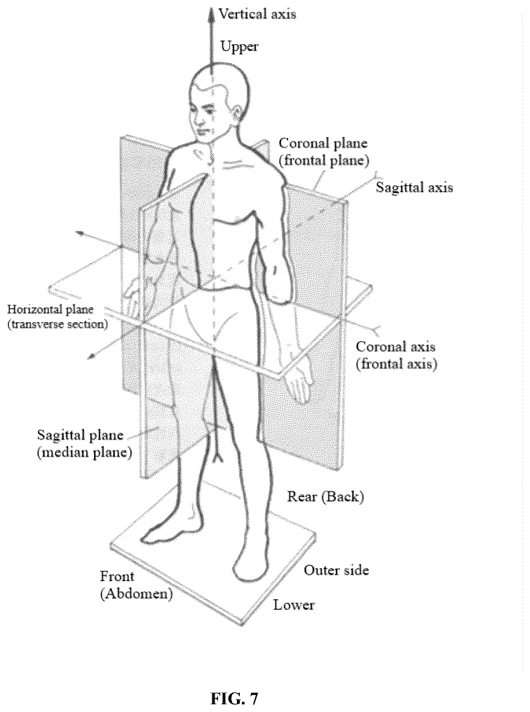

Referring to FIG. 7, it may be known that in fields such as medicine and anatomy, it is possible to define three basic sectional planes, e.g., a sagittal plane, a coronal plane, and a horizontal plane, as well as three basis axes, e.g., a sagittal axis, a coronal axis, and a vertical axis, for a human body. The sagittal plane refers to a sectional plane perpendicular to the ground taken along the anterior-posterior direction of the body, which divides the human body into two parts: left and right; the coronal plane refers to the sectional plane perpendicular to the ground taken along the left-right direction of the body, which divides the human body into two parts: front and back; the horizontal plane refers to a sectional plane parallel to the ground taken along the above-below direction of the body, dividing the human body into two parts: upper and lower. Correspondingly, the sagittal axis refers to an axis perpendicular to the coronal plane along the anterior-posterior direction of the body, the coronal axis refers to an axis perpendicular to the sagittal plane along the left-right direction of the body, and the vertical axis refers to an axis perpendicular to the horizontal plane along the above-below direction of the body.

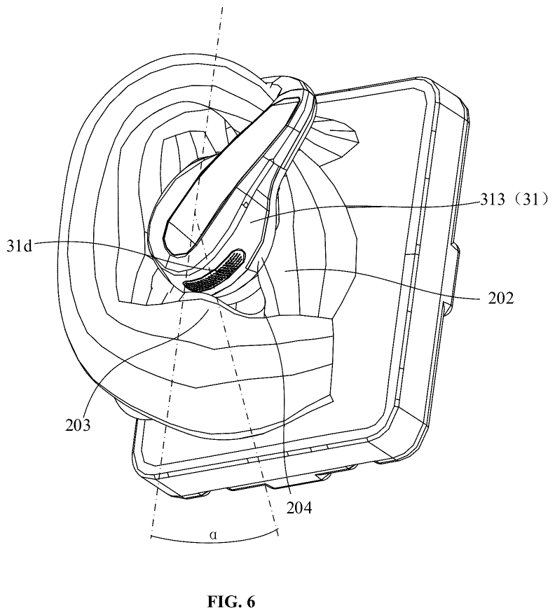

Referring to FIGS. 6 and 7 and in an example of the present application, there is an angle α between the opening direction of the pressure relief portion 31d and the vertical axis of the user in the wearing condition, satisfying the relationship: 0°≤α≤40°. In this way, it can prevent the pressure relief aperture 31d1 from directly facing forward, prevent users or others from hearing the sound coming from the pressure relief aperture 31d1, thus further reducing the sound leakage on the front side of the ear 200.

For example, in the wearing condition, the pressure relief aperture 31d1 can be positioned to open substantially towards the front side of the tragus 202 of the ear 200.

Also as an example, the pressure relief aperture 31d is located near the bottom of the rear shell 313, so that the pressure relief aperture 31d1 can face the front side of the intertragic notch 204 of the ear 200 in the wearing condition. The tragus 202, the intertragic notch 204, and the antitragus 203 of the ear 200 always enclose a notch-shaped structure therebetween. This notch is located near the ear canal opening 200a of the ear 200 and connects to the cavum conchae 200b of the ear 200. Therefore, a considerable portion of the sound near the ear canal opening 200a of the ear 200 is likely to leak from this notch. In the example of the present application, the pressure relief portion 31d faces the front side of the intertragic notch 204 of the ear 200 in the wearing condition and thus can perform targeted inverse cancellation of the sound in this area, thereby comprehensively reducing the sound leakage on the front side of the ear 200.

In the wearing condition, the pressure relief aperture 31d1 can also be provided substantially toward the front side of the intertragic notch of the ear 200 or toward the front side of the ear 200 at a higher position, and the present application has no limitation thereto.

Furthermore, the pressure relief portion 31d may be positioned to extend in the circumferential direction of the rear shell 313. For example, the pressure relief portion 31d is substantially elliptical, and it can be provided with one or more pressure relief aperture(s) 31d1. A plurality of pressure relief apertures 31d1 are arranged in the extension direction of the pressure relief portion 31d. In this way, the pressure relief portion 31d can cover a larger edge range, thereby achieving a more comprehensive effect in preventing sound leakage.

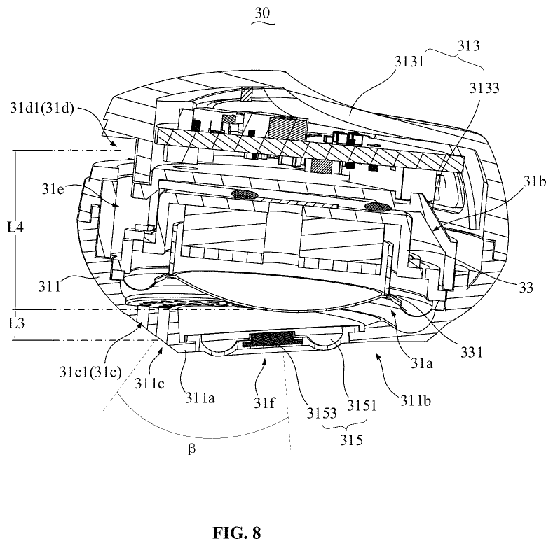

Referring to FIG. 8, in an example of the present application, the rear shell 313 comprises a rear shell body 3131 and a rear cavity cover 3133. The rear shell body 3131 is connected to the front shell 311, and the pressure relief portion 31d is located on the rear shell body 3131. The rear shell body 3131 is formed in a shell-shape which outer contour can be circular or square, the examples of present application has no limitation thereto. The periphery of the rear shell body 3131 is connected to the periphery of the front shell 311, and the rear cavity cover 3133 is located on the side of the rear shell body 3131 facing the sound emitting unit 33, so as to separate the space between the rear shell body 3131 and the sound emitting unit 33 into the rear cavity 31b and an installation space. Among them, the installation space is enclosed by the rear cavity cover 3133 and the rear shell body 3131 or by the rear cavity cover 3133, the rear shell body 3131 and part of the front shell 311, such an installation space is configured to accommodate other auxiliary accessories such as the main control panel 35. The rear cavity 31b is formed by the rear cavity cover 3133 and the sound emitting unit 33, and also formed along with the rear cavity 31b is a pressure relief channel 31e connected to the rear cavity 31b and the pressure relief aperture 31d1.

For example, the rear cavity cover 3133 comprises a base plate and lateral plates located on the periphery of the base plate. The base plate is located between the sound emitting unit 33 and the rear shell body 3131, and the lateral plates are provided to extend towards the front shell 311 with respect to the base plate. The front shell 311 is provided with a stopper step arranged along its own circumference, and the lateral plates are fittingly connected to the stopper step. In this example, both the base plate and the lateral plates are located separated from the sound emitting unit 33 to enclose and form the above-mentioned rear cavity 31b.

As a possible structural form, the pressure relief portion 31d is located on one side of the rear shell body 3131, and the rear shell body 3131 is further provided with a baffle plate opposite to the pressure relief portion 31d. The baffle plate and the pressure relief portion 31d are positioned separated from each other, thereby forming a section of channel along the extension direction of the baffle plate towards the front shell 311, which may be connected to the pressure relief aperture 31d1. There is a communicating port on the rear cavity cover 3133 near the baffle plate and at the junction of the base plate and the lateral plates. It can be understood that the communicating port can be located on the base plate or enclosed by the base plate and the lateral plates. The rear cavity cover 3133 is formed with another section of channel in the extension direction of the lateral plates, which channel is provided corresponding to and communicating with the communicating port, and communicates with the rear cavity 31b. As such, the above two channels communicate with each other through the communicating port, and combine to form a pressure relief channel 31e located on the periphery of the sound emitting unit 33 and extending in the thickness direction of the sound emitting structure 30.

With the design of the pressure relief channel 31e, the air load in the rear cavity 31b does not immediately leak out to the outside of the sound emitting shell 31 through the pressure relief aperture 31d1, in such a way that when the sound emitting unit 33 operates, each vibration of the vibrating membrane 331 may push as much air as possible within the cavity body of the rear cavity 31b to vibrate, increasing the volume of air and thus increasing the mass of air.

According to the

$$f 0 = \frac{1}{2 π} \sqrt{\frac{1}{MmCm}} ;$$

formula:
where f0 represents the resonance frequency, Mm represents the vibration mass, and the design of the pressure relief channel 31e can increase Mm to a certain extent, thereby reducing the resonance frequency f0 and improving the low-frequency presentation of the open earphone 100 to a certain extent.

The present application does not limit the structural form of the pressure relief channel 31e. For example, the channels at two ends that form the pressure relief channel 31e can be provided coaxially or non-coaxially. When provided non-coaxially, the channels can appropriately increase the complexity of the pressure relief channel 31e, thus further improving the low-frequency presentation. The extending direction of the pressure relief channel 31e and the axis of the pressure relief portion 31d can be provided substantially in the same direction or at a certain angle. When the two are provided at a certain angle, the pressure relief channel 31e can be made longer to a certain extent based on the end effect of a pipeline, thereby increasing the volume of resonant air in the rear cavity 31b and improving low-frequency presentation.

Referring to FIG. 8 again, to further improve the low-frequency presentation of the open earphone 100, and in the thickness direction of the sound emitting shell 31, there is a distance L3 between the center of the vibrating membrane 331 and the sound emitting portion 31c, and there is a distance L4 between the center of the vibrating membrane 331 and the pressure relief portion 31d, satisfying the relationship L4≥1.05 L3. The center of the vibrating membrane 331 is further away from the pressure relief portion 31d than from the sound emitting portion 31c, and the distance for the air from the vicinity of the vibrating membrane 331 to the pressure relief portion 31d is longer. The vibration of diaphragm 331 drives a larger volume and weight of gas in the rear cavity 31b, which can increase the vibration mass Mm and further reduce the resonance frequency f0, thereby improving the low-frequency sound effect of the earphone.

Additionally or alternatively, the rear shell body 3131 can be provided with one pressure relief aperture 31d1, the rear shell body 3131, the rear cavity cover 3133 and the sound emitting unit 33 form at least two pressure relief channels 31e. The at least two pressure relief channels 31e communicate with the one pressure relief aperture 31d1 so that the air inside the rear cavity 31b can escape to the outside of the sound emitting shell 31 through the at least two pressure relief channels 31e.

To prevent foreign matters from entering the pressure relief channel 31e and the rear cavity 31b through the pressure relief aperture 31d, the pressure relief aperture 31d1 may be covered with a porous mesh structure, which comprises a metal mesh, a porous etched decorative metal sheet, and/or a woven mesh.

Additionally or alternatively, the rear shell body 3131 is provided with at least two pressure relief apertures 31d1, forming a porous structure, and the rear cavity cover 3133 and the sound emitting unit 33 form at least two pressure relief channels 31e. Among them, one pressure relief aperture 31d1 is connected to at least one pressure relief channel 31e. The at least two pressure relief apertures 31d1 and the at least two pressure relief channels 31e can communicate with each other in a one-to-one manner, it is also possible that one pressure relief aperture 31d1 correspond to the at least two pressure relief channels 31e. In this way, the low-frequency presentation of the earphone and the unobstructed exhaust of the pressure relief aperture 31d1 can be ensured, which is beneficial for reducing material costs.

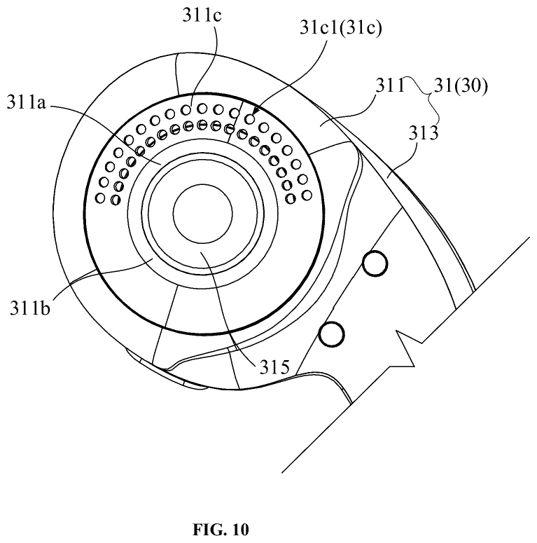

Referring to FIGS. 8 to 10, in the examples of present application, the sound emitting shell 31 is provided with a sound guiding structure 311a, the sound guiding structure 311a comprises a first surface 311b and a second surface 311c surrounding the first surface 311b. As shown in FIG. 10 specifically, the sound emitting shell 31 has a thickness direction CC, a reference plane is defined to be perpendicular to the thickness direction CC, the first surface 311b is provided at an angle γ with respect to the reference plane, and the second surface 311c is provided at an angle with respect to the first surface 311b. In an example and in the wearing condition, the above reference plane is exactly parallel with the sagittal plane of human body, which means that in this example, the first surface 311b is also provided at an angle γ with respect to the sagittal plane.

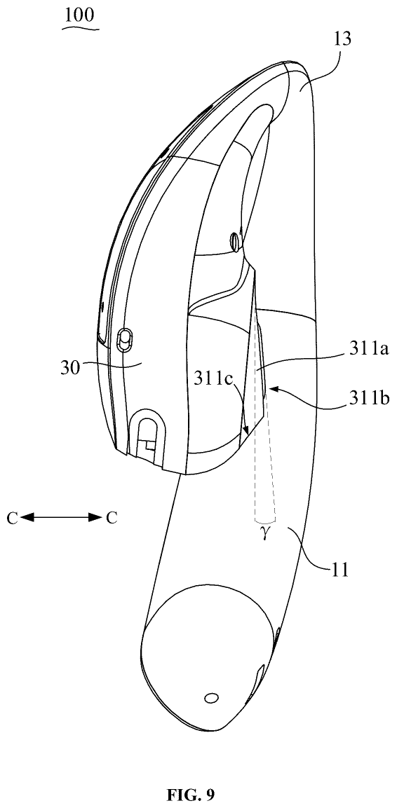

In this manner and in the above-below direction in FIG. 9, the sound guiding structure 311a gradually increases in its thickness, in such a way that, at the side of the sound emitting shell 31 facing the ear 200, the sound guiding structure 311a protrudes outwards in comparison to other parts of the sound emitting shell 31. In the wearing condition, the sound guiding structure 311a can extend further into the cavum conchae 200b of the ear 200 in comparison to other parts of the sound emitting shell 31, the sound emitting portion 31c is located on the sound guiding structure 311a, and specifically, can be located on at least one of the first and second first surfaces 311b, 311c. That is to say, the sound emitting portion 31 can be provided on the first surface 311b or on the second surface 311c, or can be provided on both the first and second surfaces 311b, 311c. Providing the sound emitting portion 31c on the sound guiding structure 311a is beneficial for the space in the cavum conchae 200b of the ear 200 to serve as a reverberation space, improving the listening effect.

Among them, 0°<γ≤20°, specifically, the angle γ may be set to 5 degrees, 10 degrees, 15 degrees, 20 degrees, or the like, which is not limited by this application. By limiting the angle γ to greater than 0 degrees and less than or equal to 20 degrees, it enables the sound guiding structure 311a to have a certain degree of protrusion while not occupying too much space near the ear canal opening 200a of the ear 200, which is beneficial for reducing the thickness of the sound emitting shell 31 and improving product competitiveness.

In some examples, at least a portion of the sound emitting portion 31c is provided on the first surface 311b, which is oriented towards the ear canal opening 200a of the ear 200. In the wearing condition, the tilted first surface 311b may make the sound emitting portion 31c oriented towards the ear canal opening 200a of the ear 200 in a greater extend, improving the directionality of the sound and allowing the sound emitted from the sound emitting aperture 31c1 to be more directly and comprehensively transmitted to the ear canal opening 200a of the ear 200, effectively improving the sound pressure level of the sound received by the human ear and making the sound clearer. It can be understood that if γ is 0° or γ>20°, the sound emitting portion 31c may deviate more from the ear canal opening 200a of the ear, resulting in poor listening effect.

Referring to FIGS. 9 and 10, in some other examples, the first surface 311b faces the inner wall of the cavum conchae 200b of the ear 200, and the second surface 311c can be arranged in an arc-shaped extension, or in a circular-ring shape for aesthetics. The sound emitting portion 31c is located on the second surface 311c, and in the wearing state, the second surface 311c covers the ear canal opening 200a of the ear 200. The sound emitted from the sound emitting portion 31c can enter the ear canal opening 200a of the ear 200.

Referring to FIG. 8 again, in one example, to improve the low-frequency presentation of the earphones, the sound emitting shell 31 comprises a shell body and a Passive radiation membrane 315. Specifically, the shell body is formed with the above-mentioned sound guiding structure 311a and provided with the first and the second surface 311b, 311c. The first surface 311b is provided with an Installation opening 31f that communicates with the front cavity 31a. The installation opening 31f may be a circular opening, and the passive radiation membrane 315 can connect to the shell body and block off the Installation opening 31f.

Among them, the passive radiation membrane 315 can be connected to the sound emitting shell 31 on the circumferential side of the installation opening 31f through adhesive or fixture. The passive radiation membrane 315, the shell body, and the sound emitting unit 33 form the afore-mentioned front cavity 31a. When the vibration of the vibrating membrane 331 of the sound emitting unit 33 drives the air in the front cavity 31a to vibrate, the passive radiation membrane 315 can vibrate therewith.

According to the

$$f 0 = \frac{1}{2 π} \sqrt{\frac{1}{MmCm}} ;$$

formula:
where f0 represents the resonance frequency, and Mm represents the vibration mass. It can be understood that the passive radiation membrane 315 is configured to increase the vibration mass Mm, thereby reducing the resonance frequency f0 and obtaining resonance peaks at low frequencies, increasing the low-frequency sound pressure level of the earphone, and improving the low-frequency presentation of the open earphone 100.

Further, in one example, the passive radiation membrane 315 comprises a membrane body 3151 and a counterweight block 3153. The membrane body 3151 conforms to the shape of the installation opening 31f, and is slightly greater than the installation opening 31f, so as to tightly connect to the shell body at the circumferential sides of the installation opening 31f and block off the installation opening 31f. The counterweight block 3153 is located at a side of the membrane body 3151 facing the front cavity 31a, and to ensure the consistency of the vibration, the counterweight block 3153 is located in the middle of the membrane body 3151. In the examples of present application, the passive radiation membrane 315 is provided with the counterweight block 3153 at a side thereof, thus further increasing the vibration mass Mm and reducing the resonant frequency f0. As an example, the resonant frequency of the passive radiation membrane 315 is less than or equal 100 Hz, which can enhance low-frequency sound and listening sensation.

In an example, the normal direction of the first surface 311b is arranged to form an angle β with respect to the normal direction of the second surface 311c, where 0°≤β≤70°. It can be understood that if β is 0°, the first surface 311b and the second surface 311c are substantially coplanar and jointly oriented towards the cavum conchae 200b of the ear 200. If 0°<β≤70. The first surface 311b and the second surface 311c may be provided at a certain angle with respect to each other, due to the limited space of the ear 200, when the first surface 311b is arranged facing the inner wall of the cavum conchae 200b of the ear 200, the second surface 311c tilted relative to the first surface 311b can face the ear canal opening 200a of the ear 200, while ensuring a sufficient volume of the front cavity 31a without interference, thereby improving sound presentation. If β>70°, an excessive angle may have an impact on the space of the front cavity 31a, therefore, in the examples of present application, the angle β between the normal direction of the first surface 311b and the normal direction of the second surface 311c is defined to 0°≤β≤70°, which is beneficial for improving sound presentation.

Furthermore, in the wearing condition, there is a distance L1 between the second surface 311c and the antihelix 201 of the ear 200, with 0 mm<L1≤15 mm. It can be understood that in this way, the second surface 311c can avoid contact with the antihelix 201, so that the sound emitting aperture 31c1 is not blocked, and at the same time, a portion of the space of the ear canal opening 200a of the ear 200 can be fully utilized for sound scattering and reverberation, which is conducive to achieving better listening effects.

Moreover, in the wearing condition, there is a distance L2 between the second surface 311c and the ear canal opening 200a of the ear 200, and 1 mm≤L2≤40 mm. It can be understood that if L2 is less than 1 mm, it can affect the user's ability to distinguish external sounds, and if L2 is greater than 50 mm, the sound outlet becomes too far from the ear canal opening 200a of the ear 200, users may not be able to fully hear the sound emitted from the sound outlet. Therefore, the examples of present application may require 1 mm≤L2≤40 mm, which ensures that the earphone are in an open condition and users can hear external sounds, and also enables the open earphones 100 to have a good sound effect.

Furthermore, referring to FIG. 9, in the present example of the application, the sound emitting portion 31c is provided in a fan-shape, and the center of the fan-shape is located in the middle of the front shell 311. The sound emitting portion 31c is distributed near the edge of the sound guiding structure 311a. In the wearing condition, the sound emitting portion 31c can better cover the ear canal opening 200a of the ear 200, thereby further improving the listening effect of the open earphone 100.

Additionally or alternatively, the sound emitting portion 31c is provided with a sound emitting aperture 31c1 with a fan-shaped opening. To prevent foreign matters from entering the front cavity 31a through the sound emitting aperture 31cl, the sound emitting portion 31c is covered with a porous mesh structure, which comprises metal mesh, porous etched decorative metal sheets, and/or woven mesh.

Referring to FIG. 9 again, in another possible example of the present application, the sound emitting portion 31c comprises a plurality of sound emitting apertures 31c1 coupled to or in the front cavity 31a, forming a porous structure. Among them, a plurality of the sound emitting apertures 31c1 are uniformly arranged on the second surface 311c and along the extension direction of the sound emitting portion 31c.

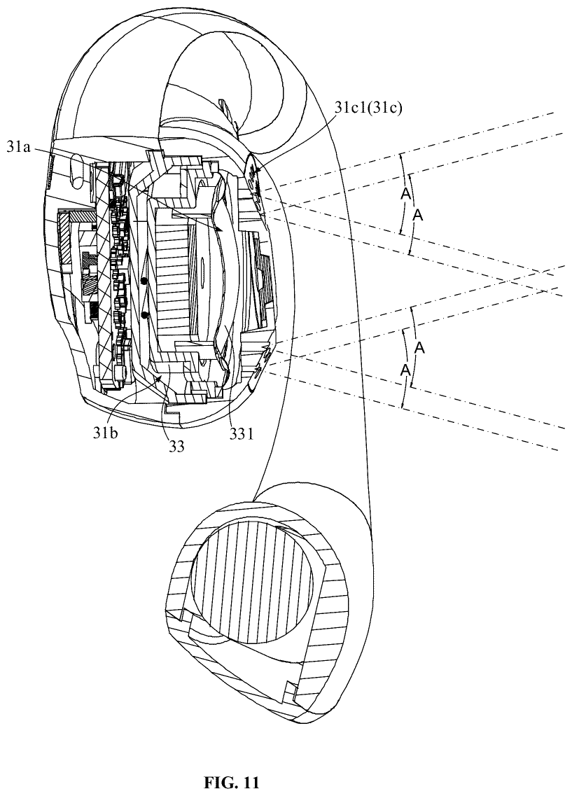

As shown in FIG. 11, due to the scattering and diffraction of sound waves, the sound wave emitted from each of the sound emitting apertures 31c1 diverges in a fan-shape, and the fan-shaped sound waves from a plurality of sound emitting apertures 31c1 may form a superposition. Due to the proximity of the earphones to the ear canal and the fact that the superimposed sound waves are all emitted from the sound emitting apertures 31c1 with the same phase, the superimposed area can enhance the sound and make the sound heard by the user clearer.

Combining FIG. 3 again, additionally or alternatively, the sound emitting aperture 31c1 has an aperture depth L and an aperture diameter D, satisfying the relationship: L/D>0.35. It can be understood that if the aspect ratio L/D is less than or equal to 0.35, the scattering angle of sound waves is larger, whereas the examples of present application limits L/D to be greater than 0.35, which can obtain a smaller scattering angle and better directionality of the sound wave, thus improving listening effect for the user.

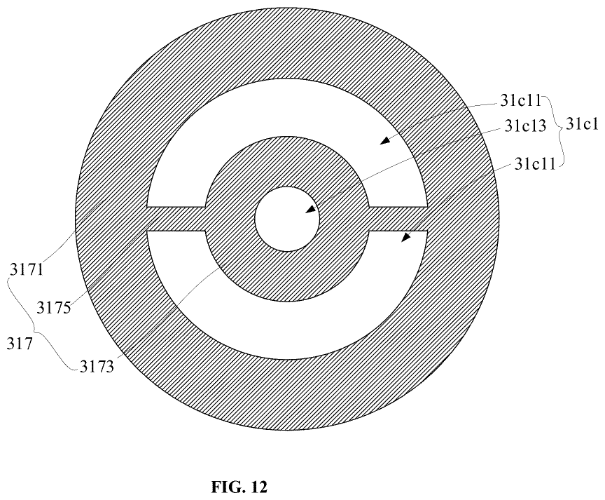

In order to further improve the user's experience, referring to FIGS. 12 to 15, the open earphone 100 also has a distribution structure 317. The distribution structure 317 is located on the sound emitting portion 31c, so as to fit the sound emitting shell 31 to form at least two sound emitting openings 31c11, such that the sound waves propagate through the at least two sound emitting openings 31c11 to the outside of the sound emitting shell 31.

It can be understood that the sound emitting portion 31c is provided with an assembly opening communicating with the front cavity 31a. The distribution structure 317 can be integrally formed within the assembly opening, and separates the assembly opening into at least two sound emitting openings 31c11. In other structural forms, the distribution structure 317 can also be a structure independent of the sound emitting shell 31, including a cover structure and an assembly body. The cover structure is configured to cover the side of the sound emitting shell 31 facing the ear 200, and at least cover the sound emitting portion 31c. The assembly body protrudes towards the interior of the sound emitting shell 31 with respect to the cover structure and extends into the assembly opening. Among them, it can be that the assembly body itself is provided with sound emitting openings 31c11, or it can be that the assembly body and the inner wall of the assembly opening are configured to form the sound emitting openings 31c11, so that the sound emitting opening 31c11 could communicate with the front cavity 31a. The examples of present application have not limitation thereto.

In practical use, due to the large amplitude of vibrating membrane 331 during operation, the air flow rate is prone to be too fast, resulting in the easy generation of turbulence, so that the sound propagated through the sound emitting portions 31c carry turbulent noise, which affects the user's auditory experience. On this basis, by using the distribution structure 317, at least two sound emitting openings 31c11 are formed in the sound emitting portion 31c, which can enable turbulent noise to propagate outward through the at least two sound emitting openings 31c11 of smaller sizes. By separating the large eddy flow noise into at least two small eddy flow noise through the at least two sound emitting openings 31c11, the energy of turbulent noise can be reduced, thereby reducing the auditory impact of turbulent noise on users and improving the user's experience.

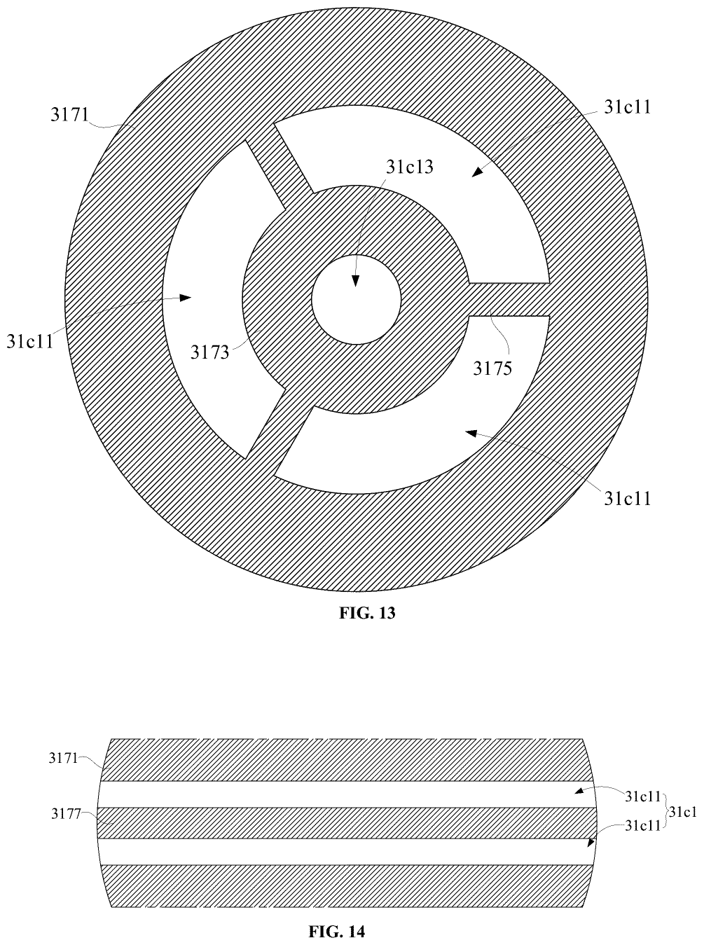

Referring to FIGS. 12 and 13, the distribution structure 317 can include a distribution body 3171, a distribution ring 3173, and a plurality of first distribution ribs 3175.

The distribution body 3171 can be in a cylindrical structure, connected to the inner wall surface of the assembly opening and arranged in a hollow configuration. The distribution ring 3173 is in a ring structure and located on the inner side of the distribution body 3171. A plurality of first distribution ribs 3175 are respectively connected to the distribution body 3171 and the distribution ring 3173, and arranged at intervals along the circumferential direction of the first distribution column; among them, the surfaces of the adjacent two first distribution ribs 3175 facing each other, the inner wall surface of the distribution body 3171, and the outer wall of the distribution ring 3173 together define the sound emitting openings 31c11. With such a configuration, the assembly opening can be separated into a plurality of sound emitting openings 31c11 by the distribution structure 317, such as the two first distribution ribs 3175 shown in FIG. 12 or the three first distribution ribs 3175 shown in FIG. 13, and the sound emitting opening 31c11 can be finally fan-shaped in its cross-sectional shape. With such a configuration, the large eddy flow noise can be separated into at least two small eddy flow noises, thereby reducing the energy of turbulent noise.

Furthermore, the distribution ring 3173 can be arranged in a hollow configuration, and the inner wall surface of the distribution ring 3173 encloses an internal sound emitting opening 31c13, which communicates with the front cavity 31a. In this way, the turbulent noise can not only propagate outward through the at least two sound emitting openings 31c11 of smaller sizes, but also propagate outward through the internal sound emitting opening 31c13, achieving further separation of turbulent noise, so as to further reduce the auditory impact of turbulent noise on users and improve their use experience.

As shown in FIG. 14, the distribution structure 317 comprises a plurality of second distribution ribs 3177 arranged at intervals along the width direction of the assembly opening. The second distribution ribs 3177 extend along the length direction of the assembly opening, where the surfaces of adjacent two second distribution ribs 3177 facing each other together define the sound emitting openings 31c11. Specifically, the cross-sectional shape of the assembly port can be substantially rectangular, and the sound emitting aperture 31c1 can be separated into at least two sound emitting openings 31c11 by a second distribution rib 3177 extending along the length direction of the assembly opening. The sound emitting opening 31c11 can be finally rectangular-shaped in its cross-sectional shape, so as to achieve the effect of separating large eddy flow noise into at least two small eddy flow noise and reducing the energy of turbulent noise.

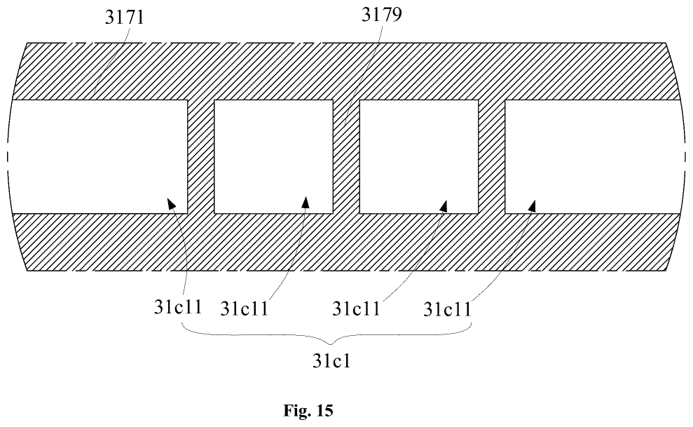

As shown in FIG. 15, the assembly port is configured in an elongation shape, and the distribution structure 317 comprises a distribution body 3171 and a plurality of third distribution ribs 3179. The distribution body 3171 is connected to the inner wall surface of the assembly opening and provided in a hollow configuration. A plurality of third distribution ribs 3179 are connected to the inner side of the distribution body 3171 and arranged at intervals along the length direction of the assembly opening. Among them, the distribution body 3171 and the third distribution ribs 3179 together define the sound emitting openings 31c11. Specifically, the cross-sectional shape of the assembly port can be substantially rectangular, and the assembly opening can be divided into at least two sound emitting openings 31c11 by the third distribution rib 3179 and the distribution body 3171. The sound emitting opening 31c11 can be finally substantially rectangular-shaped in its cross-sectional shape, so as to achieve the effect of separating large eddy flow noise into at least two small eddy flow noise and reducing the energy of turbulent noise.

The same or similar signs in the drawings of this example correspond to the same or similar parts; in the description of this application, it should be understood that if there are terms such as “up”, “down”, “left”, and “right” indicating oriental or positional relationships based on the orientation or positional relationships shown in the drawings, it is only for the convenience of describing the present application and simplifying the description, and not to indicate or imply that the device or elements referred to must have a specific orientation, be formed and operated in a specific orientation. Therefore, the terms used to describe the positional relationship in the attached drawings are only for illustrative purposes and cannot be understood as restrictions on the present application. For ordinary technical personnel in this field, the specific meanings of the above terms can be understood based on specific circumstances.

The above are only preferred examples of this application and are not intended to limit the present application. Any modifications, equivalent substitutions, and improvements made within the spirit and principles of this application shall be included within the scope of protection of this application.

What is claimed is:

1. An open earphone comprising:
a hook-shaped body; and
a sound emitting assembly connected to the hook-shaped body, wherein the sound emitting assembly comprises:
a sound emitting shell comprising one or more sound emitting apertures and one or more pressure relief apertures; and a sound emitting device in the sound emitting shell, wherein the sound emitting device is located between the one or more sound emitting apertures and the one or more pressure relief apertures,
wherein the sound emitting device is configured to transmit sound via at least the one or more sound emitting apertures, and
wherein the one or more pressure relief apertures are closer to an ear canal opening of an ear than the one or more sound emitting apertures when the open earphone is worn on the ear.

2. The open earphone according to claim 1, wherein the sound emitting assembly is configured to cover the ear canal opening of the ear and does not extend into the ear canal opening of the ear.

3. The open earphone according to claim 1, wherein the one or more pressure relief apertures are located near a bottom of the sound emitting shell.

4. The open earphone according to claim 1, wherein the sound emitting shell comprises:
a front shell forming a front cavity together with the sound emitting device, the one or more sound emitting apertures being provided on the front shell; and
a rear shell connected to the front shell and forming a rear cavity together with the sound emitting device, the one or more pressure relief apertures being provided on the rear shell.

5. The open earphone according to claim 4, wherein the rear shell comprises:
a rear shell body connected to the front shell, the one or more pressure relief apertures being provided on the rear shell body; and
a rear cavity cover provided between the rear shell body and the sound emitting device; and
a pressure relief channel connected to the rear cavity and the one or more pressure relief apertures.

6. The open earphone according to claim 1, wherein:
the sound emitting shell comprises a sound guiding structure protruding outward relative to other parts of the sound emitting shell,
the sound guiding structure comprises a first surface and a second surface surrounding the first surface,
the first surface is provided at an angle γ with a sagittal plane of a user wearing the open earphone, and the second surface is provided at an angle with the first surface, and
the one or more sound emitting apertures are provided on at least one of the first and second surfaces, and 0<γ≤20°.

7. The open earphone according to claim 6, wherein the one or more sound emitting apertures comprise a plurality of sound emitting apertures, and each of the plurality of sound emitting apertures has a depth L and a diameter D, and L/D>0.35.

8. The open earphone according to claim 6, wherein the first surface faces an inner wall of a cavum conchae of an ear, the second surface faces the ear canal opening of the ear, and at least part of the one or more sound emitting apertures are located on the second surface.

9. The open earphone according to claim 8, wherein a distance L1 is between the second surface and an antihelix of the ear, and 0 mm<L1≤15 mm; and
a distance L2 is between the second surface and the ear canal opening of the ear, and 1 mm≤L2≤40 mm.

10. The open earphone according to claim 6, wherein a direction of the first surface is set at an angle β with a direction of the second surface, where 0°≤β≤70°.

11. The open earphone according to claim 6, wherein:
the first surface is provided with an installation opening, and
the open earphone further comprises a passive radiation membrane connected to the sound emitting shell and is configured to block the installation opening.

12. The open earphone according to claim 11, wherein the passive radiation membrane comprises:
a membrane body connected to the sound emitting shell and blocking the installation opening; and
a counterweight block provided on a side of the membrane body in the membrane body.

13. The open earphone according to claim 12, further comprising: a distribution body connected to an inner wall surface of the sound emitting shell and is in a hollow configuration;
a distribution ring located on an inner side of the distribution body; and
a plurality of first distribution ribs connected to the distribution body and the distribution ring, wherein the plurality of first distribution ribs are arranged at intervals along a circumferential direction of the distribution body.

14. The open earphone according to claim 13, wherein the distribution ring is provided in a hollow configuration, and an inner wall surface of the distribution ring encloses an inner sound emitting opening.

15. The open earphone according to claim 13, further comprising a plurality of second distribution ribs arranged at intervals along a width direction of the one or more sound emitting apertures, wherein the plurality of second distribution ribs extend in a length direction of the one or more sound emitting apertures, and wherein a sound emitting opening is located between surfaces of two adjacent second distribution ribs of the plurality of second distribution ribs.

16. The open earphone according to claim 1, wherein an angle between an opening direction of the one or more pressure relief apertures and a vertical axis of a user is between 0° and 40°.

17. The open earphone according to claim 1, wherein:
the sound emitting device comprises a vibrating membrane, and
a distance L3 between a center of the vibrating membrane and the one or more sound emitting apertures, and a distance L4 between the center of the vibrating membrane and the one or more pressure relief apertures, satisfy the relationship L4≥1.05 L3.

18. The open earphone according to claim 1, wherein the hook-shaped body comprises:
a hanging portion connected to the sound emitting assembly and configured to hang between an upper side of the ear and a head of a user; and
a rear end portion configured to be provided between a rear side of the ear and the head of the user and to clamp the ear together with the hanging portion, so that the sound emitting assembly is located on a front side of the ear.

19. The open earphone according to claim 1, wherein:
the sound emitting device divides an inner space of the sound emitting shell into a front cavity and a rear cavity,
the one or more sound emitting apertures are located in the front cavity, and
the one or more pressure relief apertures are located in the rear cavity.

20. An earphone comprising:
a body; and
a sound emitting assembly connected to the body, wherein sound emitting assembly comprises:
a sound emitting shell comprising a plurality of sound emitting apertures and a plurality of pressure relief apertures, wherein the plurality of sound emitting apertures and the plurality of pressure relief apertures are located on different sides of the sound emitting shell; and
a sound emitting device in the sound emitting shell, wherein the sound emitting device is configured to transmit sound via the plurality of sound emitting apertures and the plurality of pressure relief apertures.
